(19) United States
(12) Patent Application Publication
(10) Pub. No.: US 2006/0213751 A1
(43) Pub. Date: Sep. 28, 2006

(54) Palletiser of objects

(75) Inventor: Mauro Giovanelli, Basilicagoiano (IT)

Correspondence Address: BROWDY AND NEIMARK, P.L.L.C.;624 NINTH STREET, NW, SUITE 300, WASHINGTON, DC, 20001-5303, US

(73) Assignee: ZECCHETTI - S.R.L., Montecchio Emilia (IT)

(21) Appl. No.: 11/378,648

(22) Filed: Mar. 20, 2006

(30) Foreign Application Priority Data
Mar. 25, 2005 (IT) RE2005A000034

(51) Int. Cl. B65G 47/26

(52) U.S. Cl. 198/426

(57) ABSTRACT

A palletiser (1) of objects (100) comprising: a mobile loading trolley (10) provided with a plurality of corridors (11) defined by a pair of sides (12); supporting conveyor means of said objects (100) comprising an advancing plane (2), having a first portion (2a) outside the trolley (10) and a second portion (2b) inside the trolley (10), said advancing plane (2) making the objects (100) advance along the corridors (11); an additional plane (6) coplanar to said advancing plane (2) on which the compacting of the objects to be picked up by a mobile transfer head (20) takes place, where the two sides (12) of each pair of sides (12) are mobile between a separated position, in which they do not interfere with the advancing of the objects (100) in the corridor (11) and a close together position with said objects (100) in between that are compacted, the picking up of the objects (100) by the mobile transfer head (20) being carried out when the trolley (10) is positioned over said additional plane (6).

The present invention refers to a palletiser of objects, in particular of light and unstable plastic bottles, having a neck by which they are gripped.

More specifically, the present invention refers to a palletiser capable of palletising bottles known as “shaped bottles”, like for example those that are oval or pyramid shaped, often without collar, which cannot be transported with normal air conveyors.

Palletisers of this type are known, which have a mobile loading trolley equipped with horizontal corridors, generally in a number varying from two to four, parallel to each other, suitable for receiving the bottles.

Each corridor of the trolley is defined by a pair of lateral sides arranged separated by a distance such as not to interfere with the forward movement of the bottles and by a stop element of the bottles arranged downstream of each corridor.

The loading of the trolley is carried out through a conveyor belt, lying horizontally, having a portion outside the trolley provided with channels aligned with the corridors of the mobile trolley and a portion inside the trolley arranged beneath the lateral guides to support the bottles between the sides from below and move them forwards along the corridors towards the stop elements arranged downstream.

At the end of the filling of the trolley, the latter moves forward perpendicularly to the axis of the corridors to accompany the bottles on a collection belt arranged coplanar and next to the conveyor belt. Once it has arrived on the collection belt, the trolley lifts up releasing the bottles on the collection belt then pulls back and goes back down to go back into the initial position, i.e. above the conveyor belt, ready to receive the next rows and so on.

The collection belt, in turn, advances in the direction of sliding of the trolley, to compact the bottles that are progressively released by the trolley when it lifts up.

The cycle ends when an amount of bottles equal to those necessary for the formation of a palletisation layer has been compacted on the collection belt, said layer then being picked up by a head provided with mechanical grippers.

So that the bottles can be picked up correctly by the mechanical grippers, it is necessary for them to be arranged in an organised manner on the collection belt. Quite often “shaped bottles” fail to remain organised during the compacting step, as on the other hand can occur more easily with cylindrical bottles, in such a way causing obstruction to the correct operation of the machine.

Indeed the mechanical grippers are arranged in an organised manner and are unable to pick up the bottles arranged disorganised.

Moreover, the use of a trolley that as well as carrying out an alternative movement must also lift up to release the bottles on the collection belt and lower down to go back onto the conveyor belt, implies a rather complex construction.

Therefore, there is a great requirement to have a palletiser of objects whose collection system of the objects to be picked up is simple and safe, making the operating cycles of the palletiser shorter with substantial reduction of the idle times, above all with “shaped bottles”.

The purpose of the present invention is to provide a palletiser of objects having structural and functional characteristics such as to satisfy the aforementioned requirements and at the same time to avoid the drawbacks mentioned with reference to the prior art.

Such a purpose is accomplished through a palletiser of objects in accordance with claim 1.

The dependent claims outline preferred and particularly advantageous embodiments of the palletiser of objects according to the invention.

Further characteristics and advantages of the invention shall become clear from reading the following description provided as a non-limiting example, with the help of the figures illustrated in the attached tables, in which:

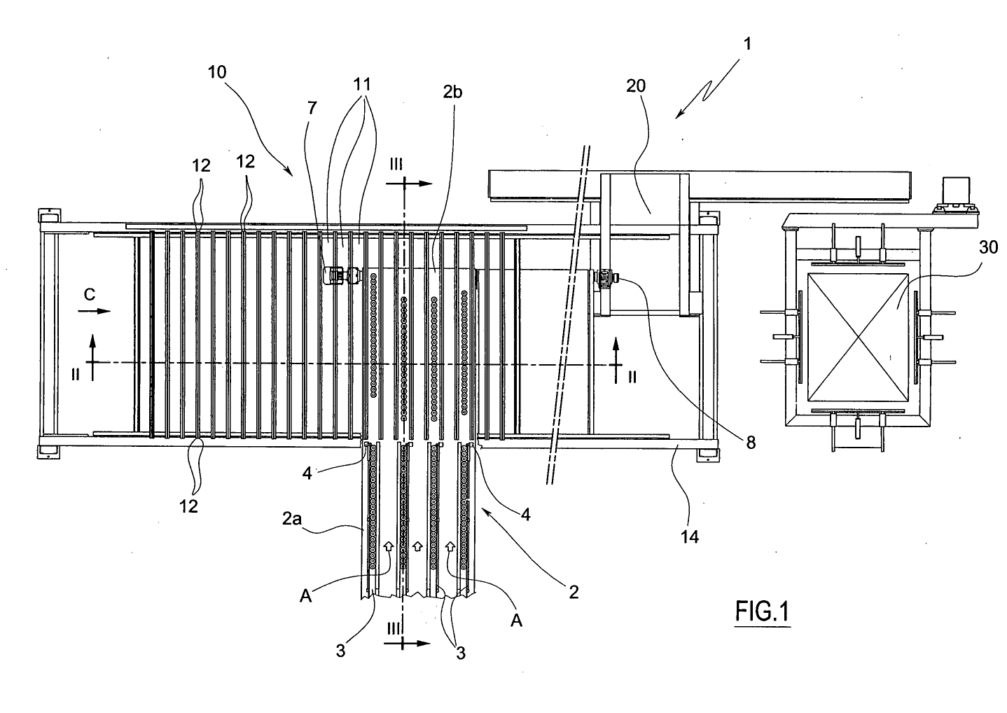

FIG. 1 shows a schematised plan view from above of a palletiser according to the invention and of the relative plant part;

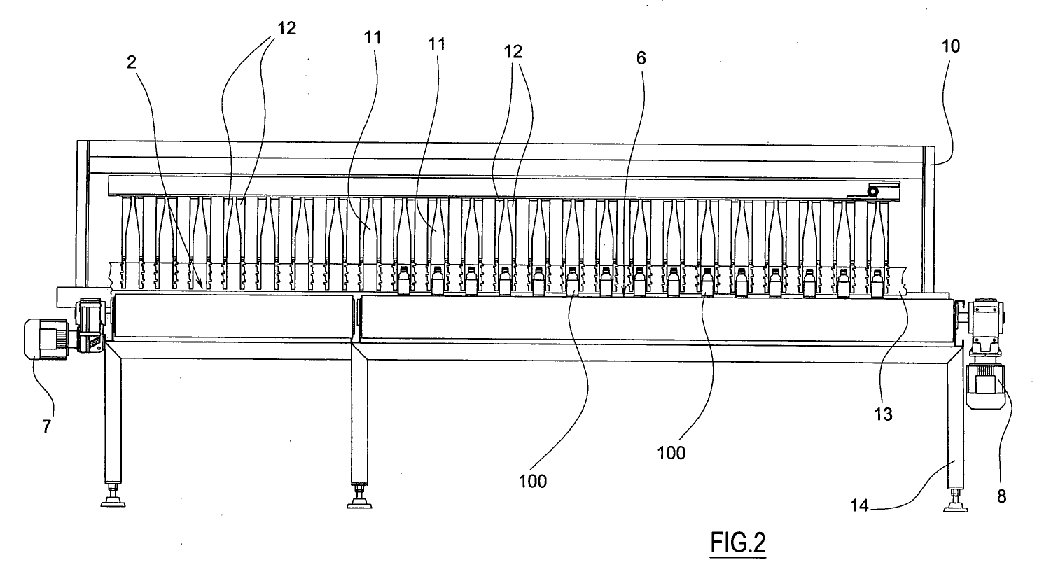

FIG. 2 shows a section view along the line II-II of FIG. 1;

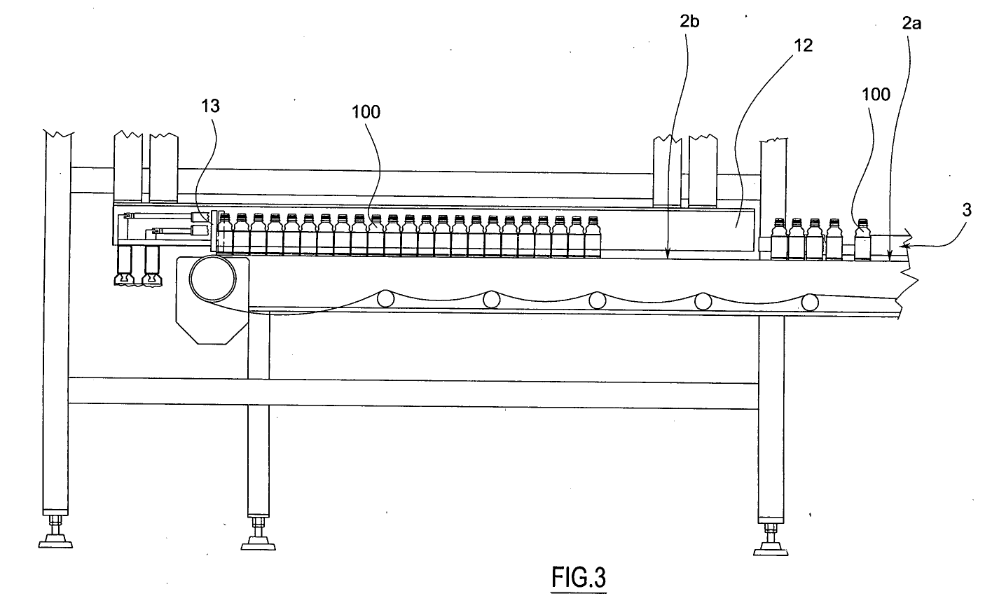

FIG. 3 shows a section view along the line III-III of FIG. 1;

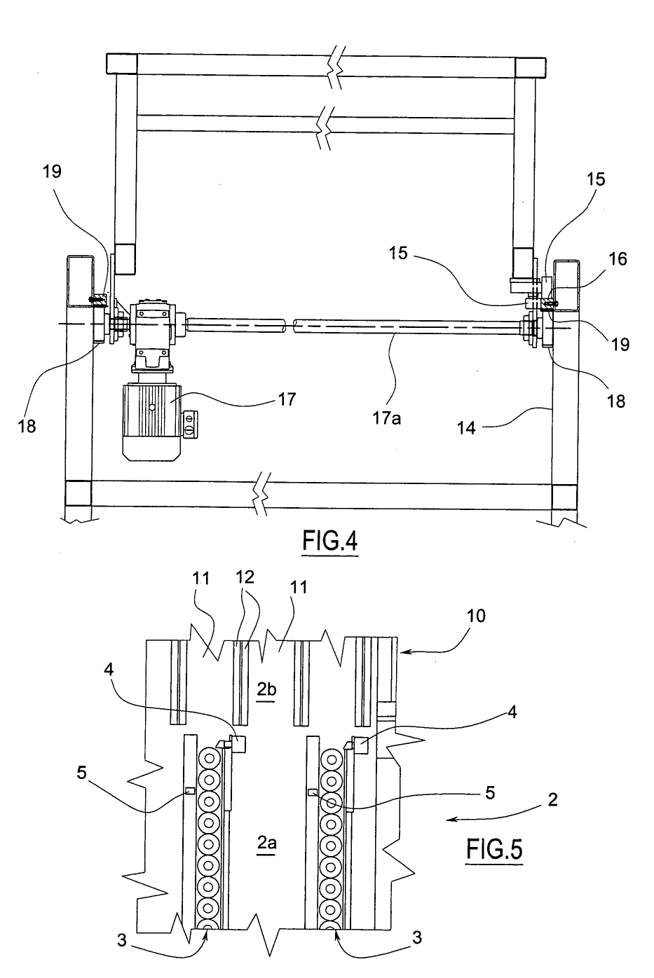

FIG. 4 shows a detail of the system for moving the trolley seen from the arrow C of FIG. 1;

FIG. 5 shows a detail of the point of entry of the objects to the trolley.

With reference to the aforementioned figures, a palletiser of objects in accordance with the present invention is globally indicated with 1.

Said palletiser 1 allows objects to be palletised, in particular empty containers of plastic material, like bottles 100 with a neck.

The palletiser 1 in brief comprises a mobile loading trolley 10 provided with a plurality of horizontal corridors 11, parallel to each other, suitable for receiving the bottles 100. Each corridor 11 is provided with a pair of lateral containing sides 12 (FIG. 3) and with a stop body 13 (FIG. 2) of the bottles 100 arranged downstream with respect to the direction of arrival of the bottles 100.

For the sake of simplicity of explanation, the direction defined by the axes of the corridors 11 shall be defined as longitudinal direction.

In accordance with the present invention, the bottles 100 are loaded into the trolley 10 through support and conveyor means comprising an advancing plane, in the example a horizontal conveyor belt 2, which is arranged with a first portion 2a outside the trolley 10 and with a second portion 2b inside the trolley 10.

The first outer portion 2a is provided with parallel feeding channels 3, along which the bottles 100 are made to advance one behind the other to load the corridors 11 of the trolley 10, which are arranged aligned with the feeding channels 3.

The second inner portion 2b is arranged beneath the lateral sides 12 supporting the bottles 100 that are arranged between the sides 12 from below.

Basically, the bottles 100 transported by the conveyor belt 2 are aligned in a row in the feeding channels 3 and then loaded into the trolley 10 always with the same conveyor belt 2. The bottles 100 move forward on the conveyor belt 2 in the corridors 11, between the sides 12, until they stop caused by the stop bodies 13 arranged downstream.

In the present invention, by inner portion 2a or outer portion 2b of the conveyor belt 2 we mean the portion of the conveyor belt 2 that is repeatedly arranged inside or outside the trolley 10.

In the illustrated example, the palletiser 1 comprises a single conveyor belt 2 actuated by a motor 7 and provided with four feeding channels 3. However, it is possible to foresee the use of many parallel conveyor belts 2, each with a single feeding channel 3 or else with many feeding channels 3.

The number of corridors 11 present in a trolley 10 is generally selected according to the maximum number of rows of bottles 100 wanted for each layer of bottles 100 to be palletised. Alternatively, the number of corridors could also correspond to a part of the rows of the layer. In this case the head shall pick up the rows in different stages: for example, first picking up half a layer and then, having completed another loading cycle with the trolley, the second part of layer. For this last alternative, the head shall have two separate open-closed controls of the mechanical grippers.

In order to adjust the access of the bottles 100 to the trolley 10, suitable blocking/unblocking means 4 are arranged suitable for intercepting the bottles 100 before they are loaded into the trolley 10. Said blocking/unblocking means 4 are controlled by a bottle 100 counting system comprising detection means, such as a photocell 5, which counts the bottles 100 that pass through a certain point (FIG. 5).

Basically, the bottles 100 that fill the corridors 11, passing from the first portion 2a of conveyor belt 2 to the second portion 2b of the same conveyor belt 2, are counted through the photocell 5 that actuates the blocking/unblocking means 4 closed (blocking) once the predetermined number of bottles 100 has been reached to then actuate them open (unblocking) when there is another free corridor 11 to open.

As blocking/unblocking means, for example, it is possible to use lateral wedges 4 (FIG. 5) or pressure blocks, the latter to be used with bottles, for example, with a square base, which can be squashed by the pressure block against a side of the feeding channel 3 without undergoing deformations, blocking the access of the next bottles 100 to the trolley 10.

The trolley 10 is made to move forwards, in predetermined steps, in the transversal direction (i.e. the horizontal direction perpendicular to the longitudinal direction), towards the right in FIGS. 1 and 2, so that the feeding channels 3 are able to feed all of the corridors 11 of the loading trolley 10.

In detail and as illustrated in FIG. 4, the loading trolley 10 is slidably supported by a fixed frame 14 made up of beams that extend along the edges of a parallelepiped, which sits through idle wheels 15 on two horizontal and transversal guides 16, arranged on the two sides of the fixed frame 14. The sliding movement is actuated through a geared motor 17 that, through a shaft 17a, actuates two pinions 18 that engage in as many racks 19 fixed to the lower face of the guides 16.

In order to make the feeding operations of the trolley 10 easier, the distance between centres of two adjacent corridors 11 is equal to a fraction, in the illustrated example equal to half, of the distance between centres of two adjacent feeding channels 3.

Once the filling of the trolley 10 is complete, the bottles 100 arranged in the corridors 11 are moved, by the translation of the trolley 10, onto a further additional conveyor belt 6, arranged on the right in FIGS. 1 and 2, actuated by a motor 8, arranged coplanar to the support conveyor belt 2, which allows the completion of the journey of the bottles 100 towards the stop bodies 13, should it not yet have been completed. Alternatively and for “slow” palletisers it is possible to use a fixed support plane instead of the additional mobile belt 6. In this case, the trolley 10 is taken onto the plane only when the bottles 100 for each corridor 11 are aligned with the first of them arranged against the stop body 13.

For stop bodies, vertical plates 13 are used (FIG. 2) that are fixed alternatively to two horizontal and transversal cross members actuated through linear actuators, the latter not being illustrated. This allows the plates 13 to be arranged staggered apart by adjusting the distance between he two cross members in order to obtain an arrangement of the bottles 100 in staggered rows in the trolley 10.

Of course, the distance between the two cross members is selected according to the diameter of the bottles 100. As illustrated in FIG. 1, the palletiser 1 also comprises a mobile transfer head 20 (FIG. 1) that is actuated by suitable known moving means, for example a rotary or translating column, a robot, etc., suitable for lowering down from above and picking up the bottles 100 arranged in the loading trolley 10 through gripping means, once the trolley has reached the additional belt 6, and for transferring them into a receiver station 30, arranged at the side.

In particular, said gripping means are in the form of a plurality of mechanical grippers, not illustrated, which pick up the bottles holding them by the neck. The number of mechanical grippers is, preferably, equal to the maximum number of rows present in the layer, connected together with a fixed pitch through a pantograph system of the known type and therefore not described in detail. The change in pitch of the mechanical grippers is carried out with prior art systems according to the arrangement of the bottles 100 to be picked up.

The loading trolley 10 is advantageously provided with means for symmetrically moving the two sides 12 (FIG. 3) of each pair of sides 12 between a position close together, in which they narrow in on the sides of the bottles 100 arranged in the corridors 11 and block it in position, compacting them to better align them, and vice-versa, a separated position, in which the sides 12, are spaced apart so as not to interfere with the mechanical grippers.

In order to automate the operation of the palletiser 1, it is foreseen to use means for controlling the actuation of the members of the palletiser 1, which are programmed so that during the loading step of the bottles 100 into the loading trolley 10, the lateral sides 12 are kept in separated position, and during the step of picking up the bottles 100 by the mechanical grippers, the sides 12 (FIG. 3) are brought closer together to block the bottles 100 in aligned position. When dealing with particularly small bottles 100, the sides 12, after having been brought closer together to compact the bottles 100, are once again separated to avoid interference with the mechanical grippers.

In detail, the operation of the palletiser 1 of the present invention is the following.

The bottles 100 arrive at the trolley 10 for the formation of a palletisation layer through the conveyor belt 2 passing through the feeding channels 3. The exact amount of bottles 100 that must be loaded onto the trolley 10 is determined by the photocell counting system. The introduction of the bottles 100 into the corridors 11 of the trolley 10 takes place by aligning the corridors 11 with the fixed feeding channels 3, present on the first outer portion 2a of the conveyor belt 2. At this point the wedges 4 are actuated open to allow the bottles 100 to pass and the conveyor belt 2 accompanies the bottles 100 inside the corridors 11. When the counting system indicates the passage of a predetermined number of bottles 100, the wedges 4 are actuated closed to hold back the bottles 100 arriving. The loading trolley 10 advances step by step in the transversal direction, from left to right in FIGS. 1 and 2, so that all of its corridors 11 are for one time only aligned with a feeding channel 3, so as to fill all of the corridors 11 with the bottles 100.

If, in the presence of a plurality of conveyor belt 2, one of them seizes up before the corresponding corridor 11 has been completely filled, the trolley 10 takes the incomplete corridor 11 up to the nearest working conveyor belt 2 to complete the filling.

In this step, the lateral sides 12 are kept in separated position, distanced from the sides of the bottles 100, so as not to hinder the forward movement of the bottles 100 themselves in the corridors 11.

When the filling of the bottles 100 into the trolley 10 is complete, the latter translates until it goes onto the additional belt 6 that allows the bottles 100 to complete the journey into the respective corridors 11 until the stop body 13 has been reached, or alternatively onto the fixed support plane.

At this point, the lateral sides 12 are brought closer together so as to compact the bottles 100 in position, and when the bottles 100 are particularly small they are separated again to allow free access to the mechanical grippers.

Once compacting is complete, the transfer head 20 goes over the bottles 100 with the mechanical grippers spaced apart so that they are exactly aligned on the vertical of the corridors 11. The head 20 is then lowered, towards the loading trolley 10 and the mechanical grippers are made to penetrate through the upper part of the corridors 11 to grip the bottles 100. Finally, the transfer head 20 is taken above the receiving station 30 where it releases the group of bottles 100 packed together to form a layer for palletisation.

As can be appreciated from that which has been described, the palletiser of objects according to the present invention allows the requirements to be satisfied and the drawbacks mentioned in the introductory part of the present description with reference to the prior art to be overcome.

Indeed, said palletiser of objects allows even “shaped bottles” to be collected in an organised manner so as to be able to be easily picked up by a normal gripping head. Moreover, the palletiser according to the invention uses a trolley that is required to make extremely simple and regular movements that allows all of the difficulties encountered in the step of releasing the bottles onto the collection belt of palletisers of the prior art to be avoided, because the bottles themselves are never left but are compacted directly into the trolley and picked up from it.

Moreover, the palletiser of objects of the present invention does not require the availability of dedicated apparatus for each bottle since it is universal and possibly self-adjusting.

Of course, a man skilled in the art can bring numerous modifications and variants to the palletiser of objects described above in order to satisfy contingent and specific requirements, all of which are covered by the scope of protection of the invention, as defined by the following claims.

1. Palletiser (1) of objects (100) comprising: means for supporting and conveying said objects (100) to be palletised; a mobile loading trolley (10) provided with a plurality of parallel horizontal corridors (11) suitable for receiving the objects (100) coming from said supporting conveyor means, each corridor (11) being defined by a pair of lateral containment sides (12) and by a stop body (13) of the objects (100) arranged downstream of each corridor (11), characterised in that said supporting conveyor means comprise an advancing plane (2), lying horizontally, having a first portion (2a) outside the trolley (10) provided with at least one channel (3) aligned with one of the corridors (11) of the mobile trolley (10) and a second portion (2b) inside the trolley (10) arranged beneath the lateral guides (12) to support the objects (100) between said sides (12) from below, said advancing plane (2) making the objects (100) advance along the corridors (11) towards the-stop bodies (13).

2. Palletiser (1) according to claim 1, wherein said advancing plane comprises a conveyor belt (2).

3. Palletiser (1) according to claim 1, comprising a plurality of said advancing planes (2).

4. Palletiser (1) according to claim 3, wherein each advancing plane (2) comprises a pair of said channels (3) suitable for aligning with a corresponding pair of corridors (11).

5. Palletiser (1) according to claim 4, wherein the distance between centres of said channels (3) and said corridors (11) is constant.

6. Palletiser (1) according to claim 5, wherein the distance between centres of two adjacent channels (3) is equal to a multiple of the distance between centres of two adjacent corridors (11).

7. Palletiser (1) according to claim 1, comprising blocking/unblocking means (4) suitable for intercepting the objects (100) transported by the advancing plane (2), before they enter the trolley (10).

8. Palletiser (1) according to claim 7, wherein said blocking/unblocking means comprise wedges (4) arranged laterally and suitable for preventing the objects (100) from advancing.

9. Palletiser (1) according to claim 7, comprising detection means (5) cooperating with said blocking/unblocking means (4) and suitable for detecting the passage of said objects (100).

10. Palletiser (1) according to claim 9, wherein said detection means comprise a photocell (5).

11. Palletiser (1) according to claim 1, wherein the two sides (12) of each pair of lateral sides (12) are symmetrically mobile between a position close together and a separated position with said objects (100) in between, aligned and arranged above said advancing plane (2).

12. Palletiser (1) according to claim 1, wherein the stop bodies (13) are fixed alternatively to two horizontal and transversal cross members actuated through linear actuators.

13. Palletiser (1) according to claim 1, wherein said trolley (10) moves with alternating motion along a direction perpendicular to the corridors (11) and to the channels (3).

14. Palletiser (1) according to claim 1, comprising an additional plane (6), arranged coplanar to said advancing plane (2), on which the trolley (10) is positioned at the end of the filling of the corridors (11) with the objects (100).

15. Palletiser (1) according to claim 14, wherein said additional plane is fixed.

16. Palletiser (1) according to claim 14, wherein said additional plane (6) is mobile in the same advancing direction as said advancing plane (2) of the supporting conveyor means.

17. Palletiser (1) according to claim 1, comprising a mobile transfer head (20) provided with a plurality of gripping means suitable for picking up the objects (100) arranged in the corridors (11) of the trolley (10) and transferring them into a receiving station (30).

18. Palletiser (1) according to claim 1, wherein said objects comprise hollow bottles (100) equipped with a gripping collar, made from plastic.
